(19) United States
(12) Patent Application Publication
(10) Pub. No.: US 2004/0039909 A1
(43) Pub. Date: Feb. 26, 2004

(54) Flexible authentication with multiple levels and factors

(76) Inventor: David Cheng, Binfield (GB)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/227,612

(22) Filed: Aug. 22, 2002

(51) Int. Cl. H04L 9/32

(52) U.S. Cl. 713/169; 713/202; 382/115

(57) ABSTRACT

An authentication system and method are provided that offer greater degree of flexibility in using authentication devices while maintaining a high level of security. Roughly three parts of organization are distinguished. At the first part, an arbiter defines a plurality of authentication levels. Each authentication level distinguishes one or more authentication factors. At the second part, an authorizer selects an access authentication level from the defined plurality of authentication levels. At the third part, it is requested from an authorizee to communicate via a portable authentication device the selected access authentication level in order for the authorizee to be authorized said access. Greater flexibility is provided to an authorizer in selecting an access authentication level within the definitions set by an arbiter. Greater flexibility is provided to an authorizee in allowing modifications to an authentication level and/or authentication factors within the definitions and/or rules set by the arbiter and authorizee.

### FIELD OF THE INVENTION

The present invention relates generally to identification and authentication systems. More particularly, the present invention relates to methods and systems that allow users to select and/or modify authentication settings.

### BACKGROUND

Authentication systems and methods involve the verification of one or more authentication factors to grant access or certify the validity of an object. In the most basic form, this could relate to the possession of a key that matches the keyhole to open a door. It could also relate to the possession of a seal or a stamp that could be applied to a document to prove authority or ownership. Instead of having possession of an authentication device, one could also have knowledge of a particular password or code such as a person identification number (PIN) in combination with the use of a bankcard.

Nowadays, several biometric factors have also been implemented as authentication factors, such as, fingerprints, palm prints, retina scans, facial recognition and voice recognition in order to obtain access (See e.g. U.S. Pat. No. 5,815,252 to Price-Francis, U.S. Pat. No. 6,213,391 to Lewis, U.S. Pat. No. 6,219,439 to Burger, U.S. Pat. No. 6,325,285 to Baratelli and U.S. Pat. No. 6,353,889 to Hollingshead). The prior art also teaches the use of combinations of one or more authentication factors such as the combination of a fingerprint and a PIN to overcome problems with false positive and false negative responses.

Most of the current authentication systems specify only one authentication method. Such systems could allow a user to change an existing authentication factor defined for that particular authentication method. This is, for instance, common for a password or PIN. An original password or PIN could be changed by the user to a new password or PIN respectively. However, a user would not be allowed to change the PIN to a different type(s) of authentication factor, add or delete an authentication factor, or even change to a different authentication method. In other words, prior systems are fairly fixed and do not provide flexibility to modify to a different authentication method or to modify the type(s) of authentication factors within an authentication method. Accordingly, there is a need to improve current authentication systems to allow users the ability and flexibility to modify the method of authentication and/or type(s) of authentication factors. This would provide the user with a greater degree of flexibility in using authentication devices while maintaining a high level of security.

### SUMMARY OF THE INVENTION

The present invention overcomes the limitations in the prior art and provides an authentication system and method that allows users a greater degree of flexibility in using authentication devices while maintaining a high degree of security. The present invention provides a method and system to authorize access to an authorizee, which roughly distinguishes three parts of organization. At the first part, a plurality of authentication levels is provided. Each authentication level distinguishes one or more authentication factors. Authentication factors could be related to possession, knowledge, or a physical characteristic. In general, an authentication factor is a biometric factor or a non-biometric factor. In case more than two authentication factors are used for a particular authentication level, there could be only biometric factors, only non-biometric factors or a combination of biometric factors and non-biometric factors. At the second part, an access authentication level is selected from the defined plurality of authentication levels. At the third part, the selected access authentication level is used, via a portable authentication device, in order to authorize the access. Access in the present invention is used in the general sense and could be related to any type of access whereby an authorizee is required to validate him/her-self. Access could be granted to physical areas, such as properties or devices, or non-physical domains, such as data networks, wireless communications, software applications, tools, documents, or Internet sites.

In general, the present invention distinguishes an arbiter that defines the plurality of authentication levels and authentication factor(s) for each of the plurality of authentication levels. In some cases, the authentication factors could be organized in groups. Furthermore, the arbiter could define processing rules. The present invention further distinguishes an authorizer that selects an access authentication level from the defined plurality of authentication levels. In some cases, the arbiter and authorizer could be the same entity, however, in most cases the arbiter and authorizer are different entities, which are usually related to the ownership of the property or rights to the system that requires authentication. The arbiter could be the manufacturer making the system and defining the levels and factors, after which the arbiter sells the system to the authorizer. The authorizer then becomes the new owner and can determine how to use the system and what level of security is needed or required for an authorizee to be granted access. In other words, the authorizer has the flexibility to select any of the authorization levels as the arbiter defined them. Furthermore, the authorizer has the flexibility to define certain control rules. Important to note is that in the request and communication of the access authentication level, the authorizer is not necessarily aware of the authentication factors that will be entered by the authorizee.

In the system and method of the present invention, the authorizee has the flexibility to select one or more alternative authentication factors as long as the alternative authentication factors have been defined as equal in quality of authentication or security in the access authentication level. The arbiter usually defines in the processing rules which authentication factors could be used as alternative authentication factors when the authorizee fails to successfully communicate the required authentication factors.

The authorizee also has the flexibility to modify the access authentication level to a different authentication level, which is then selected from the defined plurality of authentication levels. Furthermore, the authorizee has the flexibility to modify one or more authentication factors within the hierarchy of definitions and rules set forth by the arbiter. Modifications could be adding one or more new authentication factors or deleting one or more existing authentication factors. The authorizes is also entitled to define operating rules within the limitations set forth in the processing rules.

In some cases, it might be necessary to communicate the authentication level, through an electronic identifier. The electronic identifier represents a unique identification of the access authentication level entered by the authorizee. The unique identification could be a public-key certificate and/or a value associated with said public-key.

The authorizee carries the portable authentication device, which is used to get authorization access. The portable authentication device includes a communication means to receive a request for an access authentication level in order for the authorizes to be authorized or granted access. The portable authentication device includes a modifying means to allow the authorizes to modify the access authentication level and/or factors within a hierarchy of rules. In order for the portable authentication device to be compatible for all the complimentary actions that could be necessary for the communication, the portable authentication device further includes an entering means for entering the authentication factors, a scanning means to scan some of the authentication factors, a displaying means to display information to the authorizee, a communication means to communicate the requested information, and a storing means to store information or data related to the authentication level and authentication factors. Furthermore, the portable authentication device includes a processing means to perform cryptography from data received associated with an access authentication level.

The present invention also provides an authentication system for authorizing access to an authorizee. This system includes an arbiter to define a plurality of authentication levels, an authorizer to select an access authentication level from the defined plurality of authentication levels, and a portable authentication device carried by an authorizee. In addition, the system includes a request for the authorizee from the authorizer to communicate to the authorizer, via the portable authentication device, the access authentication level. Once the requirements as set forth in the access authentication level are met and successfully validated, the authorizee is granted access. Furthermore, the portable authentication device in the authentication system of the present invention includes a modifying means to allow the authorizee to modify access authentication level(s) and authentication factor(s).

In view of that which is stated above, it is the objective of the present invention to provide a flexible authentication system with multiple authentication levels and factors.

It is still another objective of the present invention to provide an authentication system and method with a greater degree of flexibility in using authentication devices while maintaining a high degree of security.

It is still another objective of the present invention to provide flexibility to an authorizer to select an access authentication level within the definitions set by an arbiter.

It is still another objective of the present invention to provide greater confidence to an authorizer knowing that authorizee must use at least the selected access authentication level to initiate required cryptography functions.

It is still another objective of the present invention to provide flexibility to an authorizee to modify an authentication level and/or authentication factors within the definitions and/or rules set by the arbiter and authorizee.

It is still another objective of the present invention to provide an authentication system and method in which an authorizer may not be aware of the precise authentication factors that are used by an authorizee.

It is still another objective of the present invention to use a portable authentication device carried by the authorizee to communicate information related to the authentication.

It is still another objective of the present invention to use a portable authentication device carried by the authorizee to perform cryptography on information that is associated with the access authentication level.

The present invention is advantageous over previous authentication systems and methods since it offers a greater degree of flexibility to authorizer and authorizee in using authentication devices without jeopardizing the level of security that is desired.

### BRIEF DESCRIPTION OF THE FIGURES

The objectives and advantages of the present invention will be understood by reading the following summary in conjunction with the drawings, in which:

FIG. 1 shows the different levels of the authentication system and method according to the present invention;

FIG. 2 shows an example of different authentication levels according to the present invention;

FIG. 3 shows an example of different authentication levels containing different authentication factors according to the present invention;

FIG. 4 shows an example of organizing authentication factors in groups according to the present invention;

FIG. 5 shows an example of the portable authentication device according to the present invention;

FIG. 6 shows an example of using electronic identifiers and certificates to certify the electronic identifiers according to the present invention;

FIG. 7 shows an example of a crypto document handling according to the present invention; and

FIG. 8 shows a flow chart depicting document decryption according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

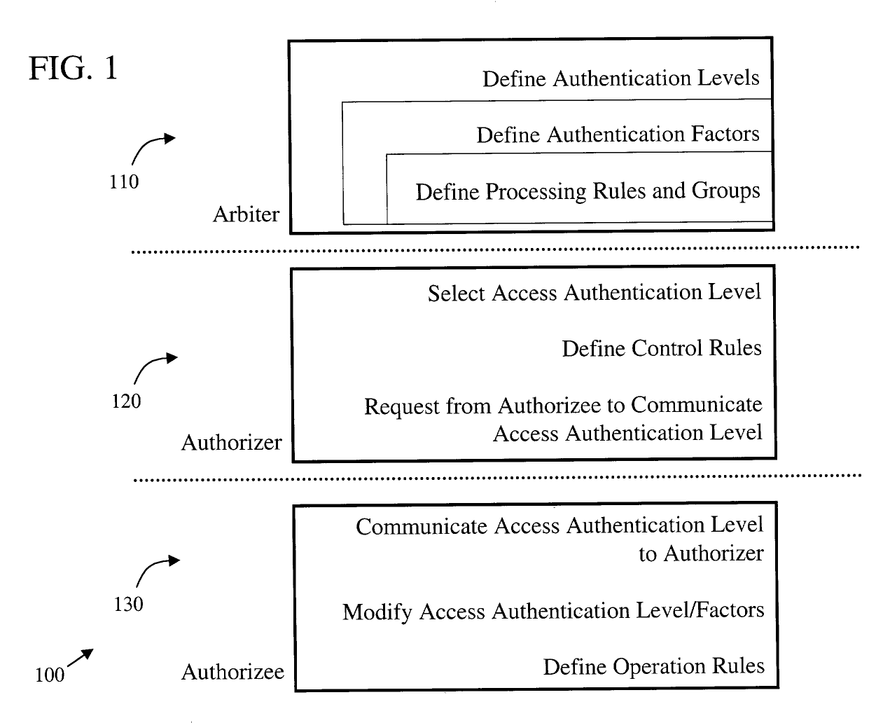

The present invention provides a method and system 100 to authorize access to an authorizee as shown in FIG. 1. Access could, for instance, be granted to open a door, start the ignition of a car, to place transactions through a bank machine, open software application or a document, enter Internet sites or portals, enter a chat room on the Internet, open parental guided Internet sites, gain access to secured (physical and non-physical) areas, or the like. As a person of average skill to which the present invention pertains would readily appreciate, the present invention could be applied in a variety of different applications, which could be related to network, wireless communication, software, hardware and/or physical devices or properties.

FIG. 1 distinguishes three parts. The first part 110 relates to providing a plurality of authentication levels, wherein each of the plurality of authentication levels includes one or more authentication factors. The second part 120 relates to selecting an access authentication level from the plurality of authentication levels that were provided in first part 110. The third part 130 relates to communicating via a portable authentication device the selected access authentication level in order to authorize the access. In general, an arbiter is associated with first part 110, an authorizer is associated with second part 120 and an authorizee is associated with third part 130. An arbiter, who is usually a manufacturer or original owner of a property, machine, software or device, defines the different authentication levels. Within each authentication level, the arbiter defines the required authentication factors. For some cases, an arbiter could define groups of different authentication factors and/or processing rules in case those are required for the particular authentication system. Processing rules are set by the arbiter and define the processing within the device that requires authentication. Processing rules govern the hierarchy of the authentication levels, the grouping of the authentication factors within a given authentication level, the processing sequence of the authentication factors and/or groups within the given authentication level. For example, processing rules include rules that define any alternative authentication factors that need to be communicated by the authorizes when the authorizee fails to successfully authenticate on the specific factor.

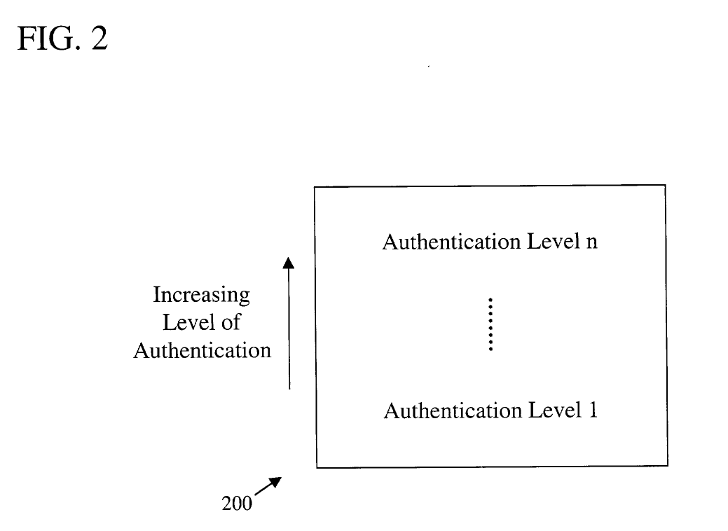

At the first level 110, the arbiter defines a plurality of authentication levels such as authentication level 1 to authentication level n as shown in FIG. 2. The present invention is not limited to the number of different authentication levels and could also just have one authentication level. The key idea is that in case there are two or more authentication levels, there is an increasing level of authentication. An increasing level of authentication is associated with an increasing level of confidence in security. In the example shown in FIG. 2, there could be a plurality of n authentication levels each with different levels of security confidence. For instance, authentication level 1 could have the lowest level of authentication and authentication level n could have the highest level of authentication.

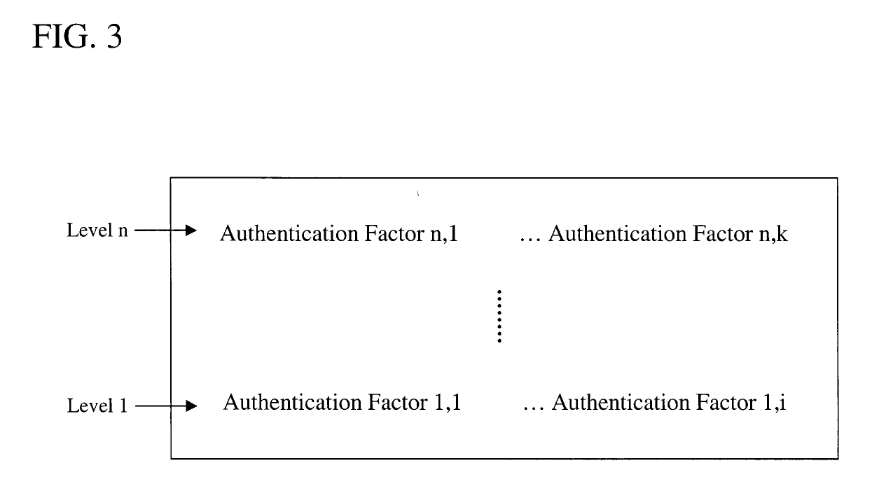

As shown in FIG. 3, each authentication level includes one or more authentication factors. FIG. 3 shows level 1 having authentication factors 1 to i, whereby i could be any integer number starting from 0 (if i is 0, then there would only be 1 authentication factor for that level). FIG. 3 also shows level n having authentication factors 1 to k, whereby k could be any integer number starting from 0 (if k is 0, then there would only be 1 authentication factor for that level). In the present invention, an authentication factor could be a non-biometric or a biometric factor. Examples of non-biometric authentication factors are for instance, but not limited to, PIN, password, pass-phrase, software keys, bar codes, or the like. Examples of biometric authentication factors are for instance, but not limited to, one or more finger prints, specific features of finger prints, palm prints, retina scans, facial recognition, voice recognition, or the like. Biometric authentication factors could either be supplied through an external device, i.e. any biometrics captured with sensors that are not part of the portable authentication device, or through on-board scanning mechanisms or sensors that are part of the portable authentication device. Furthermore, the authentication factors could also be distinguished by authentication factors related to possession (such as possession of the portable authentication device) or knowledge (such as knowledge of a PIN, etc). In general, each authentication level has at least one authentication factor. In case there are two or more authentication factors per authentication level, it would be preferred to have a combination of biometric factors and non-biometric factors, however this would not be necessary. Furthermore, in case there are two or more authentication factors per authentication level, the authentication factors are defined by having similar quality of authentication or security. An example of 7 different authentication levels is shown in the following TABLE 1, whereby 7 authentication levels are distinguished by having different authentication factors. TABLE 1 is provided for illustrative purposes only and should in no way be limiting to the present invention.

TABLE 1

| Authentication Level | Authentication Factor(s) |
|---|---|
| Authentication Level 1 | Possession |
| Authentication Level 2 | PIN |
| Authentication Level 3 | Any external supplied biometrics factors |
| Authentication Level 4 | Two external supplied biometrics factors or on- |
| | board fingerprint |
| Authentication Level 5 | Any external supplied biometrics plus on-board |
| | fingerprint or PIN, or on-board Multi-digit |
| | fingerprint with 2 out of 3 minimum |
| Authentication Level 6 | Two external supplied biometrics plus on-board |
| | fingerprint or PIN, or on-board Multi-digit |
| | fingerprint with 3 out of 5 minimum |
| Authentication Level 7 | On-board multi-digit, digit specific, complete |
| | match plus PIN |

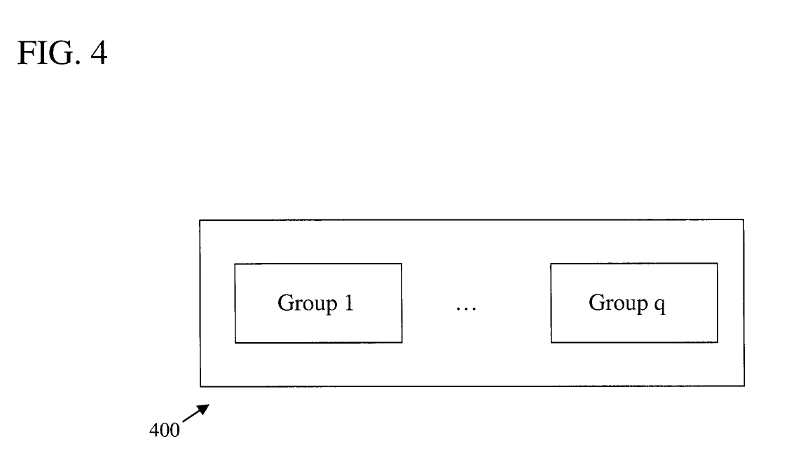

As shown in FIG. 4, each authentication level could also be organized as two or more groups whereby each group could have one or more authentication factors as shown by exemplary authentication level 400 in FIG. 4. The different groups per authentication level contain different one or more authentication factors, however, the different groups with the authentication level represent the same quality of authentication or security. FIG. 4 shows a plurality of groups starting with group 1 to group q, whereby q could be any integer number starting with 2 (q=2 indicates that there are two groups). An example of two groups with the same authentication level is, for instance, one group with a thumbprint and a PIN, and another group with a palm print and a PIN. As a person of average skill in the art to which the present invention pertains would readily appreciate, a large number of combination and variations of authentication factors would be possible for the groups and the present invention is in no way limited to this particular example.

Referring back to FIG. 1, through a transaction, e.g. a sale, the arbiter transfers the rights of the property or device to an authorizer. In some cases, the arbiter and authorizer could be the same entity and therefore in that case there would be no need for a transfer of rights. In order for an authorizee to be granted access, the authorizee needs to communicate via the portable authentication device the selected access authentication level by the authorizer. Communication could be established using the portable authentication device and connecting the portable authentication device with the device that requires authentication. However, the present invention is not limited to a physical contact between the portable authentication device and the device that requires authentication, since the communication could also be established through a non-physical contact, such as any type of wireless communication. Furthermore, communication could be established using analog signals and/or digital data formats.

In any case, the authorizer validates the communicated access authentication level before access is granted to an authorizee. Important to note is that the authorizer does not necessarily have to be aware of the type of authentication factor(s) that is/are communicated by the authorizee. The only thing an authorizer would need to know is the different authentication levels defined by the arbiter from which the authorizer would select an access authentication level that the authorizer feels comfortable with in terms of level of security. Besides selecting the access authentication level within the hierarchy of authentication levels defined by the arbiter, the authorizer is also allowed to define control rules. Control rules set by the authorizer could for instance define and limit the rights of an authorizee for the given access authentication level. Examples of control rules are, for instance, a limitation on the dates of access, the time of access, the location of access, or the like. Various functions could also be defined in the control rules. Examples of functions are for instance, but not limited to, unlock a door, start a car ignition, decrypt a document, access to unit A and not to unit B, or the like. The authorizer could also define and allow a guest of the authorizee. Like the authorizee, the guest would then have his/her own unique set of authentication factors.

Within the hierarchy of authentication levels and definitions of authentication levels and factors defined by the arbiter, the authorizee is allowed to modify the type of authentication level and/or modify different authentication factors. The authorizee would be allowed to modify the access authentication level to a different alternative authentication level as long as the arbiter has defined the different authentication levels and as long as the arbiter or authorizer did not specify a rule that would prevent the authorizee from making this modification. The authorizee is also allowed to select one or more alternative authentication factors, as long as the alternative authentication factors have similar quality of authentication as the authentication factors that are defined in the access authentication level. This would allow an authorizee for instance to select an alternative authentication factor in case the authorizee is not able to communicate the intended authentication factor. An example would be that the requested authentication factor is a thumbprint and the authorizee just recently had an injury (e.g. a cut from a knife in that thumb), which prevents the authorizee from communicating the intended thumbprint. An alternative authentication factor could be the use of an index fingerprint instead of a thumbprint. The authorizee could also modify an authentication factor for instance by adding one or more new authentication factors. The newly added authentication factor would then be stored on the portable authentication device. The new authentication factors could include biometric factor(s), non-biometric factor(s) or a combination of the biometric factor(s) and the non-biometric factor(s). The authorizee could also delete one or more authentication factors. Furthermore, the authorizee could change from one group to another group within the specified authentication level. The authorizes is also entitled to define operating rules within the limitation sets forth in the processing rules. Operating rules are, for instance, related to preferences for the authorizee in using the portable authentication device, sequence of how the authorizee wants to enter the authentication factors, sounds, alarms, and any other specific setting. A person of average skill in the art to which the present invention pertains would readily appreciate that the processing rules are mostly dependent on the type of authentication system that is used.

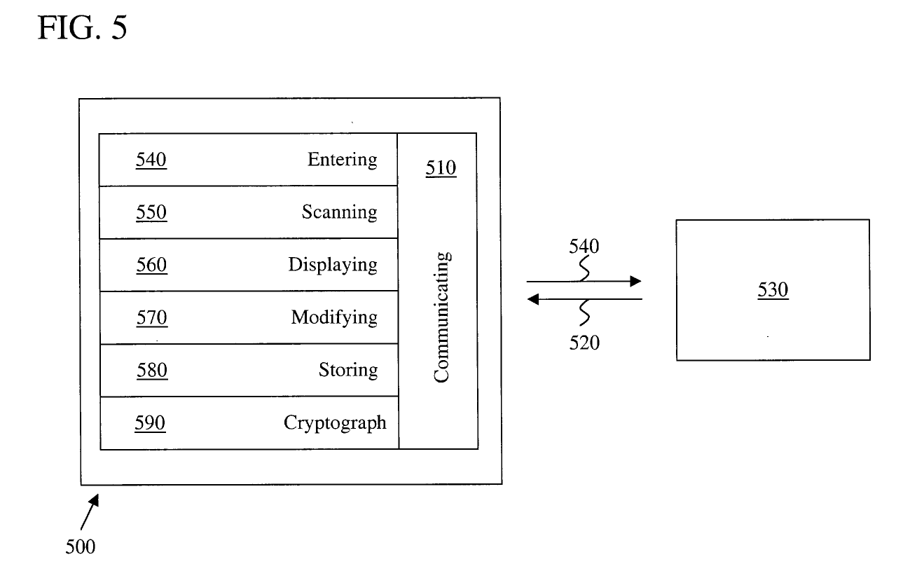

FIG. 5 shows a portable authentication device 500 according to the present invention. Portable authentication device 500 is in possession by the authorizee after the rights of the portable authentication device have been successfully transferred to the authorizee. The portable authentication device enables authorizee to communicate the requested access authentication level and obtain access. That is, once an authorizee obtains his/her portable authentication device, the authorizee needs to request validation of his/her authentication factors. The type of authentication factors that need to be validated is depended on the access authentication level, which is, as discussed above, selected by the authorizer. Once the validation is successful, the authorizee has possession of the portable authentication device and can start using it to obtain access and/or modify the authentication level and/or authentication factors.

As shown in FIG. 5, portable authentication device 500 includes a communication means 510. Communication means 510 includes the necessary hardware and software to receive 520 requests and communication from the device or system 530 that request authorization. Communication means 510 also includes the necessary hardware and software to send 540 communications to device or system 530. As described above, the communication could be through either a physical contact or wireless communication. Portable authentication device 500 further includes an entering means 540 to enter the requested authentication factors. Examples of entering means 540 are, for instance, a keypad, sensing pads, touch-panel, or any type of scanning means 550 to scan in various types of codes (e.g. bar codes) or scan in all kinds of biometric features. Sensors and devices to enter or scan in non-biometric or biometric information are commercially available and known in the art. Scanning means could be onboard of portable authentication device 500. However, scanning means is not limited to be external from portable authentication device 500 such as a facial detection camera that is mounted near the device that requires authentication.

Portable authentication device 500 further includes a displaying means 560 through which authorizee obtains information, such as requests, questions on what to do or enter, feedback on the entered response whether it was successful or not, etc. The information could be displayed using a small screen or any other display means that is commercially available and known in the art. Displaying means also lists the order of authentication factors that needs to be entered.

Portable authentication device 500 further includes a modifying means 570 to enable authorizee to modify authentication level(s) or factor(s) as described above. Modifying means 570 includes the necessary algorithms and software to intelligently and securely interpret the requested modifications.

Portable authentication device 500 further includes a storing means 580 to store authentication information such as the defined authentication levels and factors entered by the authorizee. The stored information on storing means 580 could be used to verify and compare on portable authentication device 500 the entered authentication factors by the authorizee with previously stored authentication factors. This would be helpful for almost all, if not all, of the authentication factors. Furthermore, this would also avoid the need to have a remote database to verify or check the authentication factors entered by the authorizee. In the present invention, the verification could be done immediately on portable authentication device 500.

Portable authentication device 500 further includes a cryptograph means 590. Cryptograph means 590 could include means to perform encryption, decryption, or a digital signature. The cryptography is used to establish secured communication between authentication device 500 and device or system 530. Furthermore, cryptography could be used to store secured information on storing means 580, cipher cryptic communication to/from authorizer, and handling of digital signatures and certificates. The cryptograph methods and algorithms that could be used in the present invention are known in the art and commercially available. Portable authentication device 500 also includes the necessary hardware and software, which are well-known in the art, to make the connections between all the different means such as the communication means, entering means, displaying means, modifying means, storing means, and cryptograph means 590.

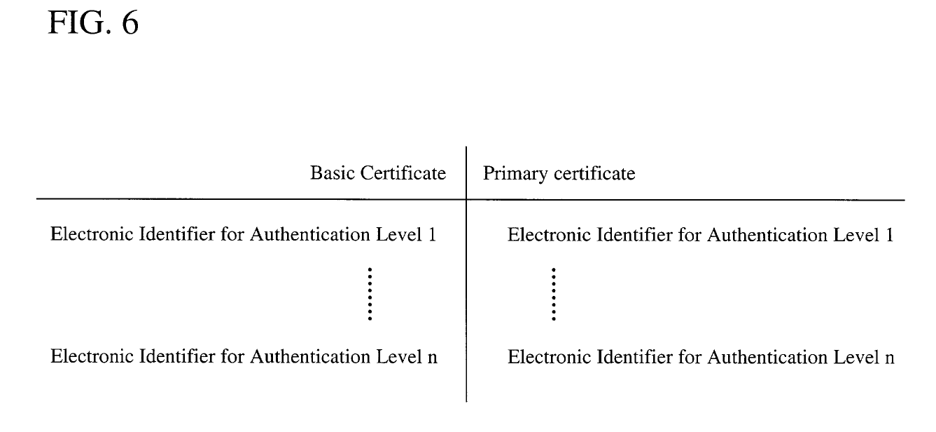

In some cases, it might be necessary to communicate the authentication level, and thus the authentication factor(s), through an electronic identifier. The electronic identifier represents a unique identification of the access authentication level and authentication factors entered by the authorizee. The unique identification could be a public-key or an identifier unique to the authorizee and authentication level. Furthermore, the electronic identifier could be certified with different degrees of trust or certification to ensure that the authentication factors entered by the authorizee are valid, true and/or correct. For example, a basic certificate or a primary certificate could be obtained providing different classes of certification of the electronic identifier as shown in FIG. 6. The key idea is that a certification of the electronic identifier establishes a degree of certainty or validity of the authentication factors of that particular authorizee. A third party could for instance certify the electronic identifier to establish a primary certificate. A basic certificate could be granted by, for instance, a company or owner of the device or system (i.e. arbiter) who is transferring ownership or access-rights to the authorizer.

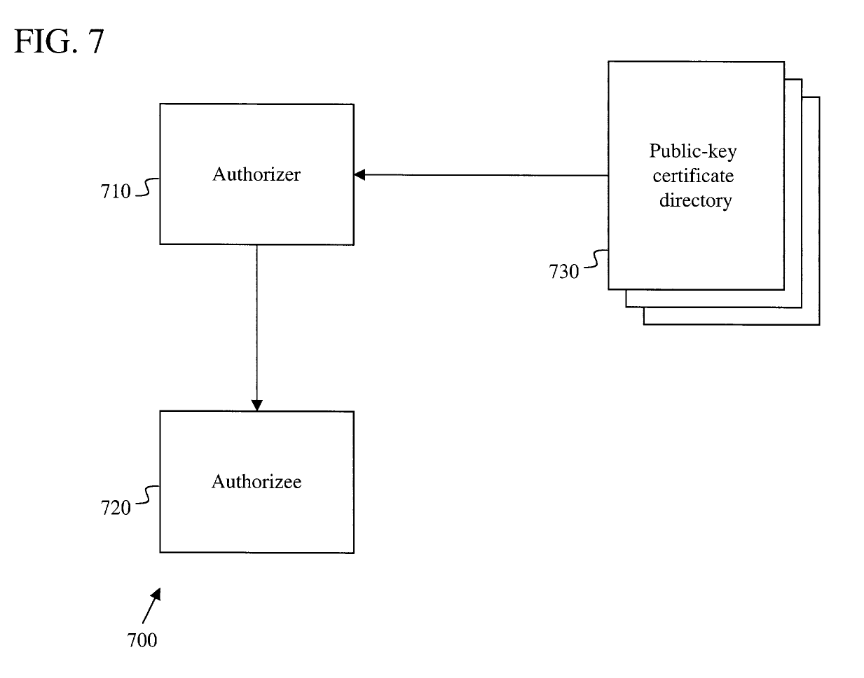

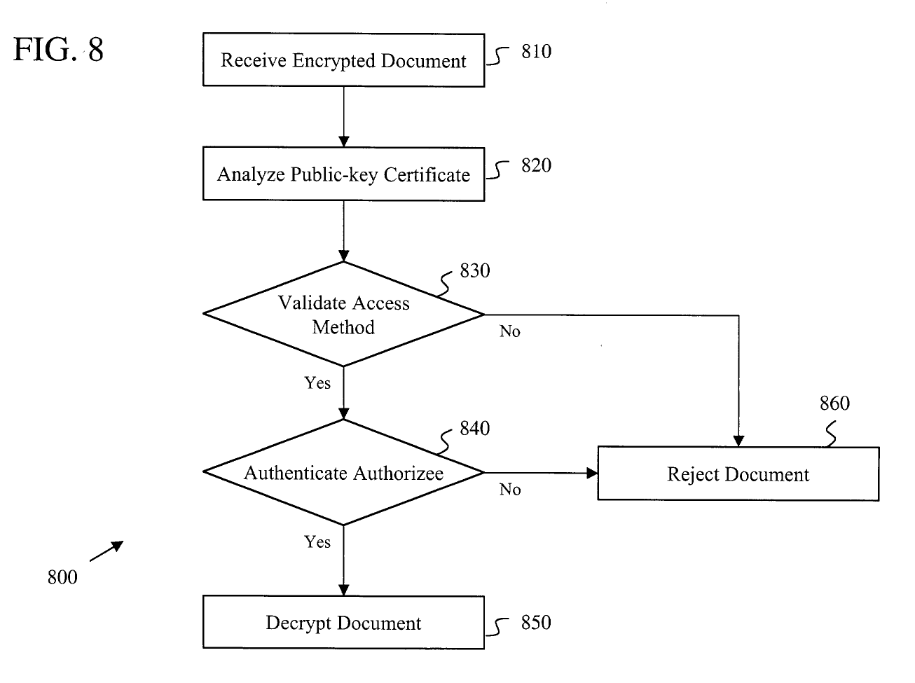

FIGS. 7 and 8 show an example of how the present invention could be applied in handling a crypto document between an authorizer and an authorizee. FIG. 7 shows the general concept of handling a crypto document whereby the authorizer 710 (also referred to as an originator) encrypts a confidential document and sends this encrypted confidential document to an authorize 720 (also referred to as the recipient). Authorizer 710 obtains an available public-key certificate of the authorizee with the specific authentication level or factor from a public-key certificate directory 730. FIG. 8 shows an example of the method steps 800 to decrypt a crypto document 810 within the portable authentication device carried by the authorizee. The authorizee receives the encrypted document 810, analyzes the attached public-key certificate 820, validates that access method 830 is supported by the portable authentication device, authenticates itself 840 in accordance with the access authentication level indicated in the certificate. Upon successful authentication the private-key is used to decrypt the document 850, otherwise the decryption is rejected 860 by the portable authentication device.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed is:

1 A method to authorize access to an authorizee, comprising:
(a) providing a plurality of authentication levels, wherein each of said plurality of authentication levels comprises one or more authentication factors;
(b) selecting an access authentication level from said plurality of authentication levels; and
(c) requesting from said authorizee to communicate via a portable authentication device said access authentication level in order for said authorizee to be authorized said access.

2. The method as set forth in claim 1, wherein an arbiter defines said plurality of authentication levels.

3. The method as set forth in claim 1, wherein an authorizer selects said access authentication level.

4. The method as set forth in claim 1, wherein an authorizer requests said communication of said access authentication level.

5. The method as set forth in claim 1, wherein said access authentication level is communicated to an authorizer and said authorizer validates said communicated access authentication level.

6. The method as set forth in claim 1, further comprising said authorizee selecting one or more alternative authentication factors, wherein said one or more alternative authentication factors have similar quality of authentication as said one or more authentication factors in said access authentication level.

7. The method as set forth in claim 1, wherein said each of said plurality of authentication levels comprises rules to define one or more alternative authentication factors that need to be communicated by said authorizee when said authorizee fails to successfully communicate said required one or more authentication factors.

8. The method as set forth in claim 1, further comprising processing rules, controlling rules or operating rules.

9. The method as set forth in claim 1, wherein said one or more authentication factors in each of said plurality of authentication levels are of similar quality of authentication.

10. The method as set forth in claim 1, wherein said one or more authentication factors comprises one or more biometric factors, one or more non-biometric factors or a combination of said one or more biometric factors and said one or more non-biometric factors.

11. The method as set forth in claim 1, further comprising said authorizee modifying said access authentication level to a different authentication level, which is selected from said plurality of authentication levels.

12. The method as set forth in claim 1, further comprising said authorizee modifying said one or more authentication factors.

13. The method as set forth in claim 1, further comprising said authorizee adding one or more new authentication factors, wherein said one or more new authentication factors comprises one or more biometric factors, one or more non-biometric factors or a combination of said one or more biometric factors and said one or more non-biometric factors.

14. The method as set forth in claim 1, further comprising said authorizee deleting one or more of said one or more authentication factors.

15. The method as set forth in claim 1, wherein said each of said plurality of authentication levels comprises two or more groups defined by an arbiter wherein each of said two or more groups comprises a different combination of said one or more authentication factors, wherein said combinations represent the same quality of authentication.

16. The method as set forth in claim 1, wherein said authentication levels or said one or more authentication factors comprise an electronic identifiers.

17. The method as set forth in claim 1, further comprising certifying said authentication levels or said one or more authentication factors.

18. The method as set forth in claim 1, further comprising requesting form said authorizes to perform cryptography functions via a portable authentication device on data received in conjunction with said communication.

19. The method as set forth in claim 18, wherein an authorizer requests said performance of cryptography functions.

20. A portable authentication device carried by an authorizes to authorize access to said authorizee, comprising:
(a) a communication means to receive a request for said authorizee to communicate via said portable authentication device an access authentication level in order for said authorizee to be authorized said access, wherein said access authentication level comprises one or more authentication factors; and
(b) a modifying means to allow said authorizee to modify said access authentication level within a hierarchy of rules.

21. The portable authentication device as set forth in claim 20, wherein an arbiter defines a plurality of authentication levels and said hierarchy of rules, and an authorizer select said access authentication level from said plurality of authentication levels.

22. The portable authentication device as set forth in claim 20, wherein an authorizer requests said communication of said access authentication level.

23. The portable authentication device as set forth in claim 20, wherein said access authentication level is communicated to an authorizer and said authorizer validates said communicated access authentication level.

24. The portable authentication device as set forth in claim 20, wherein said modifying means comprises selecting means to select one or more alternative authentication factors, wherein said one or more alternative authentication factors have similar quality of authentication as said one or more authentication factors in said access authentication level.

25. The portable authentication device as set forth in claim 20, wherein said one or more authentication factors in each of said plurality of authentication levels are of similar quality of authentication.

26. The portable authentication device as set forth in claim 20, wherein said one or more authentication factors comprises one or more biometric factors, one or more non-biometric factors or a combination of said one or more biometric factors and said one or more non-biometric factors.

27. The portable authentication device as set forth in claim 20, wherein said modifying means allows said authorizee to modify said access authentication level to a different authentication level, which is selected from a plurality of authentication levels.

28. The portable authentication device as set forth in claim 20, wherein said modifying means allows said authorizee to modify said one or more authentication factors.

29. The portable authentication device as set forth in claim 20, wherein said modifying means allows said authorizee to add one or more new authentication factors, wherein said one or more new authentication factors comprises one or more biometric factors, one or more non-biometric factors or a combination of said one or more biometric factors and said one or more non-biometric factors.

30. The portable authentication device as set forth in claim 20, wherein said modifying means allows said authorizee to delete one or more of said one or more authentication factors.

31. The portable authentication device as set forth in claim 20, wherein said each of said plurality of authentication levels comprises two or more groups wherein each of said two or more groups comprises a different combination of said one or more authentication factors, wherein said combinations represent the same quality of authentication.

32. The portable authentication device as set forth in claim 20, wherein said authentication levels or said one or more authentication factors comprise electronic identifiers.

33. The portable authentication device as set forth in claim 20, wherein said authentication levels or said one or more authentication factors are certified.

34. The portable authentication device as set forth in claim 20, further comprising communicating means for communicating said access authentication level and associated data.

35. The portable authentication device as set forth in claim 20, further comprising entering means for entering said one or more authentication factors.

36. The portable authentication device as set forth in claim 20, further comprising scanning means to scan said one or more authentication factors.

37. The portable authentication device as set forth in claim 20, further comprising displaying means to display information to said authorizee.

38. The portable authentication device as set forth in claim 20, further comprising storing means to store said one or more authentication factors.

39. The portable authentication device as set forth in claim 20, wherein said modifying means comprises software means.

40. The portable authentication device as set forth in claim 20, further comprising processing means to perform cryptography functions on data received in conjunction with said communication.

41. The portable authentication device as set forth in claim 40, wherein an authorizer requests said performance of cryptography functions.

42. A system for authorizing access to an authorizee, comprising:
(a) an arbiter to define a plurality of authentication levels, wherein each of said plurality of authentication levels comprises one or more authentication factors;
(b) an authorizer to select an access authentication level from said plurality of authentication levels;
(c) a portable authentication device carried by said authorizes;
(d) a request for said authorizee from said authorizer to communicate to said authorizer via said portable authentication device said access authentication level in order for said authorizee to be authorized said access, wherein said authorizer validates said communicated access authentication level; and
(e) said portable authentication device comprises modifying means to allow said authorizee to modify said access authentication level.

43. The system as set forth in claim 42, wherein said modifying means comprises selecting means to select one or more alternative authentication factors, wherein said one or more alternative authentication factors have similar quality of authentication as said one or more authentication factors in said access authentication level.

44. The system as set forth in claim 42, wherein each of said plurality of authentication levels comprises rules to define one or more alternative authentication factors that need to be communicated by said authorizee when said authorizee fails to successfully communicate said required one or more authentication factors.

45. The system as set forth in claim 42, further comprising processing rules, controlling rules or operating rules.

46. The system as set forth in claim 42, wherein said one or more authentication factors in each of said plurality of authentication levels are of similar quality of authentication.

47. The system as set forth in claim 42, wherein said one or more authentication factors comprises one or more biometric factors, one or more non-biometric factors or a combination of said one or more biometric factors and said one or more non-biometric factors.

48. The system as set forth in claim 42, wherein said modifying means allows said authorizee to modify said access authentication level to a different authentication level, which is selected from a plurality of authentication levels.

49. The system as set forth in claim 42, wherein said modifying means allows said authorizee to modify said one or more authentication factors.

50. The system as set forth in claim 42, wherein said modifying means allows said authorizee to add one or more new authentication factors, wherein said one or more new authentication factors comprises one or more biometric factors, one or more non-biometric factors or a combination of said one or more biometric factors and said one or more non-biometric factors.

51. The system as set forth in claim 42, wherein said modifying means allows said authorizee to delete one or more of said one or more authentication factors.

52. The system as set forth in claim 42, wherein said each of said plurality of authentication levels comprises two or more groups wherein each of said two or more groups comprises a different combination of said one or more authentication factors, wherein said combinations represent the same quality of authentication.

53. The system as set forth in claim 42, wherein said authentication levels or said one or more authentication factors comprise electronic identifiers.

54. The system as set forth in claim 42, wherein said authentication levels or one or more authentication factors are certified.

55. The system as set forth in claim 42, wherein said portable authentication device comprises communicating means for communicating said access authentication level and associated data.

56. The system as set forth in claim 42, wherein said portable authentication device comprises entering means for entering said one or more authentication factors.

57. The system as set forth in claim 42, wherein said portable authentication device comprises scanning means to scan said one or more authentication factors.

58. The system as set forth in claim 42, wherein said portable authentication device comprises displaying means to display information to said authorizee.

59. The system as set forth in claim 42, wherein said portable authentication device comprises storing means to store said one or more authentication factors.

60. The system as set forth in claim 42, wherein said portable authentication device comprises comparing means.

61. The system as set forth in claim 42, wherein said portable authentication device comprises cryptography means.

62. The system as set forth in claim 42, wherein said portable authentication device comprises software means.
